(19) United States
(12) Patent Application Publication
(10) Pub. No.: US 2007/0296992 A1
(43) Pub. Date: Dec. 27, 2007

(54) Printing System, Printing Method and Storage Medium

(75) Inventor: Toshihide TANAKA, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/426,649

(22) Filed: Jun. 27, 2006

(51) Int. Cl. G06F 3/12

(52) U.S. Cl. 358/1.13

(57) ABSTRACT

A system outputs image data created by a computer apparatus to an image forming apparatus and performs a print processing, the computer apparatus having a data conversion unit to convert, when image data created by a data creation unit is outputted to the image forming apparatus and the print processing is performed, the image data into print data based on a previously set printing condition, a dialog image creation unit to create a dialog image including a print setting screen for setting the printing condition and a confirmation screen for enabling the set printing condition to be confirmed for each item, a display unit to display the dialog image, and a display change unit to change a display order of plural setting items displayed on the confirmation screen based on an operation of a user, and the image forming apparatus includes a printer that can perform the print processing in accordance with the set printing condition.

### BACKGROUND OF THE INVENTION

1. Field of the Invention

The present invention relates to a printing system, a printing method and a storage medium, in which printing conditions of an image forming apparatus such as a printer or MFP (Multi-Function Peripherals) can be set and the set printing conditions can be confirmed.

2. Description of the Related Art

In general, an image forming apparatus such as a printer or MFP can be connected to a host equipment such as a PC (Personal Computer), and print data created by the host equipment is printed by the printer. In this case, the user uses the PC or the like to set printing conditions, controls the printer in accordance with the set printing conditions, and performs a print processing. As the printing conditions, there are, for example, a document size, a sheet size, a printing direction, the number of copies to be made and the like, and the execution of the print processing is performed by a printer driver.

Since a recent image forming apparatus has many functions, in order that the setting of printing conditions can be easily performed, a screen for printing condition setting is displayed on a display of a host equipment, and the user can select a desired condition by the operation of, for example, a mouse, a keyboard or the like. However, when the image forming apparatus becomes multifunctional, the number of setting items of the printing conditions is also increased, and accordingly, there has been a disadvantage that it takes much time to confirm the set printing conditions.

JP-A-2002-281200 discloses an image forming apparatus in which a user's operability is improved. In this example, it is disclosed that plural function selection screens are hierarchically displayed, plural function selection keys are disposed on the function selection screen of each layer, display positions of the function selection keys are rearranged in the descending order of use frequency on the function selection screen of an upper layer, and the user's function selection operation is facilitated.

In the above example, only an example is disclosed in which the function selection is performed by operating an operation unit provided in the body of the image forming apparatus, and there is no disclosure on an operation in a case where printing conditions are set by a printer driver, and on an operation in a case where the printing conditions are confirmed after the setting thereof. Accordingly, when the set printing conditions are confirmed, it is necessary for the user to search plural setting items for a relevant item, and there is a problem that the confirmation operation is troublesome.

The invention provides a printing system, a printing method and a storage medium, in which confirmation of printing conditions is facilitated.

### BRIEF DESCRIPTION OF THE DRAWINGS

FIG. 1 is a whole structural view showing a printing system of the invention.

FIG. 2 is a block diagram for explaining an embodiment of a computer apparatus used for the printing system of the invention.

FIG. 3 is a block diagram showing a structure of an image forming apparatus used for the printing system of the invention.

FIG. 4 is an explanatory view showing a dialog screen for printing condition setting in the printing system of the invention.

FIG. 5A and FIG. 5B are explanatory views for explaining a change in display order on a confirmation screen in the printing system of the invention.

FIG. 6 is a flowchart for explaining an operation of a change in display order on a confirmation screen according to the invention.

FIG. 7 is a flowchart showing the details of a change processing of display order on a confirmation screen according to the invention.

FIG. 8 is a flowchart of another embodiment for explaining the operation of a change in display order on a confirmation screen according to the invention.

FIG. 9 is a flowchart of still another embodiment for explaining the operation of a change in display order on a confirmation screen according to the invention.

FIG. 10 is an explanatory view for explaining the operation of the embodiment in FIG. 9.

FIG. 11 is a flowchart showing the details of the change processing of the display order in FIG. 9.

### DETAILED DESCRIPTION OF THE INVENTION

Throughout this description, the embodiment and example shown should be considered exemplars, rather than limitation on the systems and methods of the present invention.

Hereinafter, an embodiment of the invention will be described in detail with reference to the drawings. Incidentally, in the respective drawings, the same parts are denoted by the same symbols.

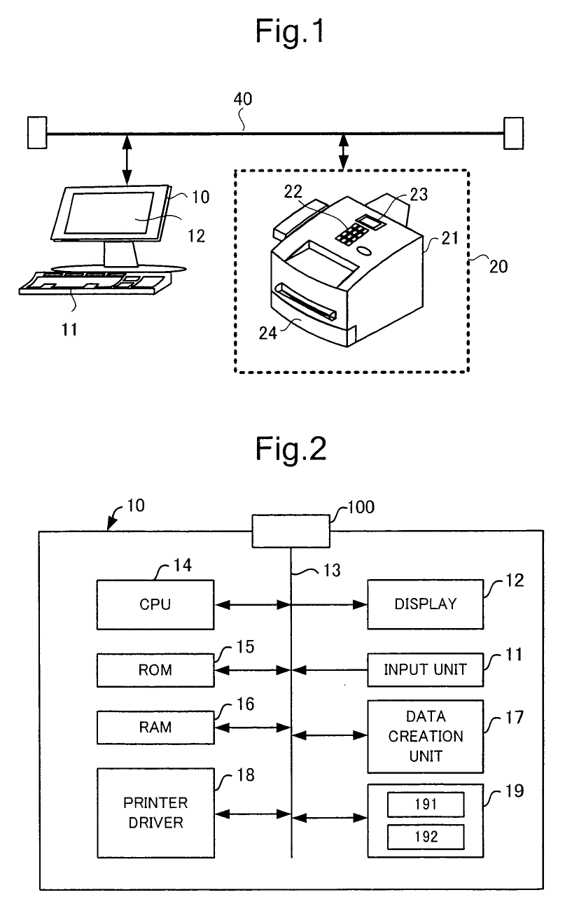

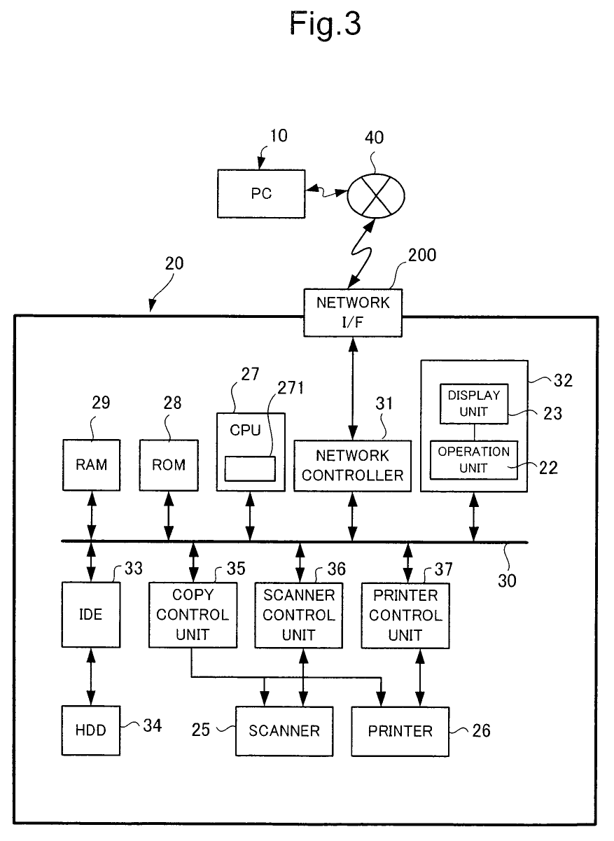

FIG. 1 is a structural view showing a printing system of the invention. The printing system includes a computer apparatus 10 having a built-in printer driver, and an image forming apparatus 20 such as a printer or MFP (Multi-Function Peripherals). The computer apparatus 10 and the image forming apparatus 20 include network interfaces 100 and 200, respectively (see FIGS. 2 and 3), and can be connected to each other through a network 40. The computer apparatus 10 includes an input unit 11 such as a keyboard or a mouse, and a display 12 as a display unit. Incidentally, in addition to the network 40, another connection means may be used.

FIG. 2 is a block diagram showing the inner structure of the computer apparatus 10. In FIG. 2, reference numeral 11 denotes the input unit such as the keyboard or the mouse; and 12, the display. The input unit 11 and the display 12 are connected to a bus 13, and the bus 13 is connected with a CPU 14, a ROM 15 and a RAM 16. The CPU 14 constitutes a central arithmetic unit and controls the computer 10 in accordance with a program stored in the ROM 14. The RAM 16 can store various data at the time of data processing.

The computer apparatus 10 further includes a data creation unit 17, a printer driver 18 and a storage unit 19, and the bus 13 is connected with the data creation unit 17, the printer driver 18, and the storage unit 19. The data creation unit 17 uses specified application software, for example, document creation software or spreadsheet software, and creates text data or image data. The printer driver 18 converts the image data or the like created by the data creation unit 17 into print data suitable for the print processing based on printing conditions set by the operation of the input unit 11, and outputs it to the image forming apparatus 20.

Besides, the printer driver 18 has a function to create a dialog image including a print setting screen for setting printing conditions such as a document size, a sheet size, a printing direction, a paper feed method, a sheet type and the number of copies to be made, and a confirmation screen for confirming the set printing conditions, and enables the dialog image to be displayed on the display 12. Further, the printer driver 18 has a display change function to change, based on the user's operation, display order of setting items displayed on the confirmation screen.

The storage unit 19 includes a program area 191 storing programs used for the printer driver 18 to realize various functions, and a data storage area 192 storing setting data such as the printing conditions and data indicating the display order on the setting screen. Besides, the bus 13 is connected to the network interface 100.

On the other hand, as shown in FIG. 1, the image forming apparatus 20 includes an operation unit 22 and a display unit 23 at an upper part of a body 21. A document table is provided at the upper part of the body 21, and an auto document feeder (ADF) is openably/closably provided on the document table. Besides, a cassette 24 in which sheets of various sizes are contained is provided at a lower part of the body 21. Further, a scanner 25 and a printer 26 shown in FIG. 3 are included in the inside of the body 11. The scanner 25 reads a document image.

FIG. 3 is a block diagram showing the structure of the image forming apparatus 20.

The image forming apparatus 20 is provided with a CPU 27. The CPU 27 includes a control unit 271 and is connected to a PCI bus 30. The PCI bus stands for Peripheral Component Interconnect Bus. The PCI bus 28 is connected with a ROM (Read Only Memory) 28 and a RAM (Random Access Memory) 29. The ROM 28 stores various control program data necessary for the operation of the image forming apparatus 20. The RAM 29 stores control information at the time of operation of respective units.

Besides, the image forming apparatus 20 is provided with the network interface 200, and the network interface 200 is connected to the PCI bus 30 through a network controller 31. The network interface 200 includes a LAN board, a FAX modem and the like, and can be connected to the computer apparatus 10 and another external equipment through a network 40. The network controller 31 controls data transmission/reception to/from the external equipment through the network interface 200.

Besides, an operation panel. 32 is connected to the PCI bus 30, and further, a HDD 34 as a storage device is connected to the PCI bus 30 through an IDE 33. The IDE 33 is an interface for connecting the HDD 34 to the PCI bus 30, and stands for Integrated Device Electronics. The operation panel 32 includes the foregoing operation unit 22 and the display unit 23.

Further, the PCI bus 30 is connected with a copy control unit 35, a scanner control unit 36, and a printer control unit 37. The control unit 271 of the CPU 27 constitutes a job management unit to control the copy control unit 35, the scanner control unit 36, and the printer control unit 37.

As job functions of the image forming apparatus 20, there are, for example, a printer function, a scan function, a network print function and the like. The printer function is a function to print image data. The scan function includes a function to copy image data read by the scanner 25, and a file function to store the image data scanned by the body 21 into an external equipment (for example, the computer apparatus 10) through the network 40. The network print function is a function to print image data, which is sent from the external equipment such as the computer apparatus 10 to the body 21, at the body 21 side.

The copy control unit 35 controls a normal copy function using the scanner 25 and the printer 26. The scanner control unit 36 controls a scan function to read a document by using the scanner 25 and a file function to store the scanned image data into the computer apparatus 10.

The printer control unit 37 controls the print function using the printer 26 or the network print function The HDD 34 stores image data used when the print processing is performed by the printer 26.

The operation unit 22 includes various keys for setting operation conditions, and includes, for example, a start key, a numeric keypad, a print key, a setting/registration key and the like. Besides, the display unit 23 of a liquid crystal or the like is provided to be adjacent to the operation unit 22.

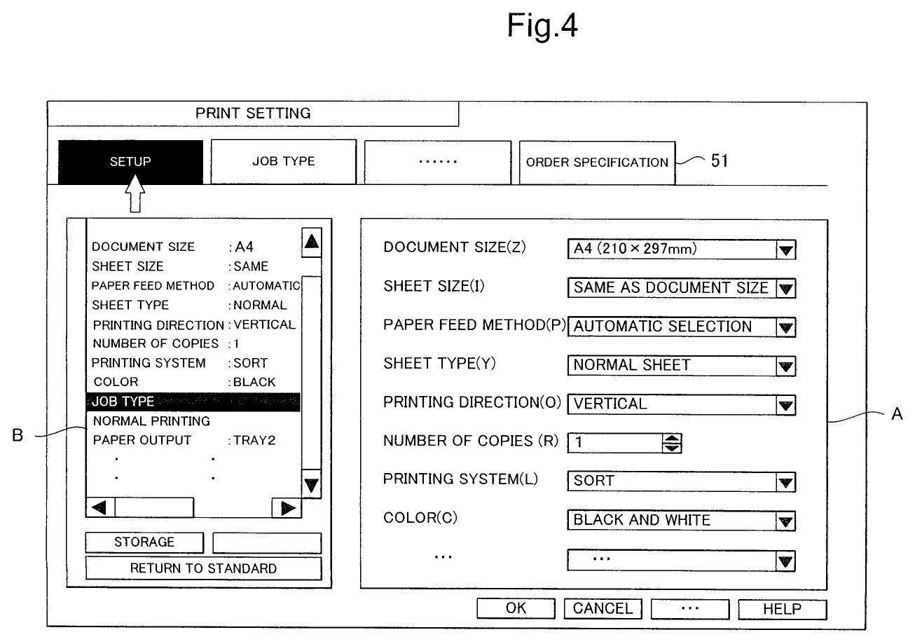

Next, the setting of printing conditions in the printing system of the invention and the way of confirming the set conditions will be described with reference to FIG. 4. The image data created by the data creation unit 17 of the computer apparatus 10 is outputted to the image forming apparatus 20 through the printer driver 18 and is print-processed. FIG. 4 exemplifies a dialog view of print setting in the computer apparatus 10.

In FIG. 4, “A” indicates a print setting screen at the setting of printing conditions, and “B” indicates a confirmation screen for confirming the set conditions. As items of the printing conditions, there are, for example, a document size, a sheet size, a paper feed method, a sheet type, a printing direction, the number of copies to be made, and the like. These items are displayed on the setting screen A, and the user can selects the printing conditions for the respective items. FIG. 4 shows an example in which the setting is made such that the document size is “A4”, the size of the printing sheet is “same as the document size”, the paper feed method is “automatic selection”, the sheet type is “normal sheet”, the printing direction is “vertical”, and the number of copies to be made is “1”. Besides, another printing condition can be set by clicking another tab.

On the other hand, the set printing conditions are listed on the confirmation screen B, and with respect to the document size, the sheet size, the paper feed method, the sheet type, the printing direction, the number of copies to be made and the like, the set conditions are displayed.

Although the set printing conditions can be confirmed by looking at the confirmation screen B, in the case where there are many setting items, it is necessary for the user to search the plural setting items for the relevant item by scrolling.

The embodiment of the invention provides the printing system in which the set printing conditions can be easily confirmed, and the user can freely specify the order of print setting items displayed on the confirmation screen B.

That is, the printer driver 18 of the computer apparatus 10 has the function to create the dialog image including the screen A for setting the print conditions and the screen B for confirming the set printing conditions, and to display it on the display 12, and can arbitrarily set the display order of the setting items of the confirmation screen B in accordance with a program stored in the program area 191 of the storage unit 19.

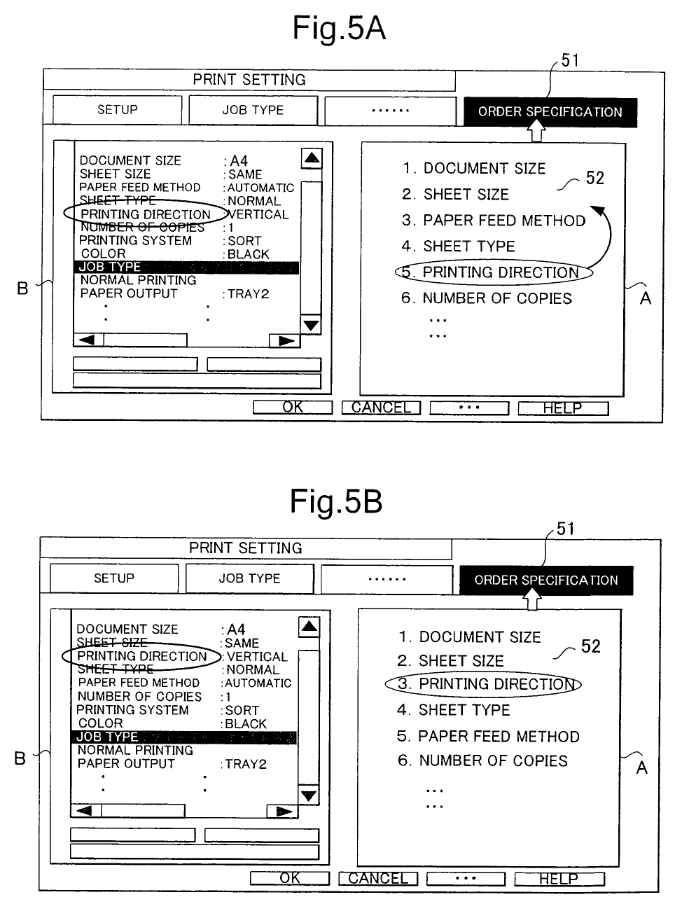

In the dialog of the print setting of FIG. 4, in order that the user can freely specify the order of the setting items displayed on the confirmation screen B, a tab 51 of “order specification” is provided in the dialog. When this tab 51 is selected, as shown in FIG. 5A, all print setting items 52 in the tab 51 are displayed in order.

When an item in the setting item 52 is rearranged by drag-and-drop or the like, as shown in FIG. 5B, it is reflected on the confirmation screen B, and the order of the items to be displayed is changed.

For example, on the confirmation screen B of FIG. 5A, the items of the document size, sheet size, paper feed method, sheet type, printing direction, number of copies to be made are arranged in order and are displayed, whereas in FIG. 5B, they are rearranged in the order of the document size, sheet size, printing direction, sheet type, paper feed method, number of copies to be made,

By doing so, when the printing conditions are confirmed, the setting items can be displayed in the order desired by the user.

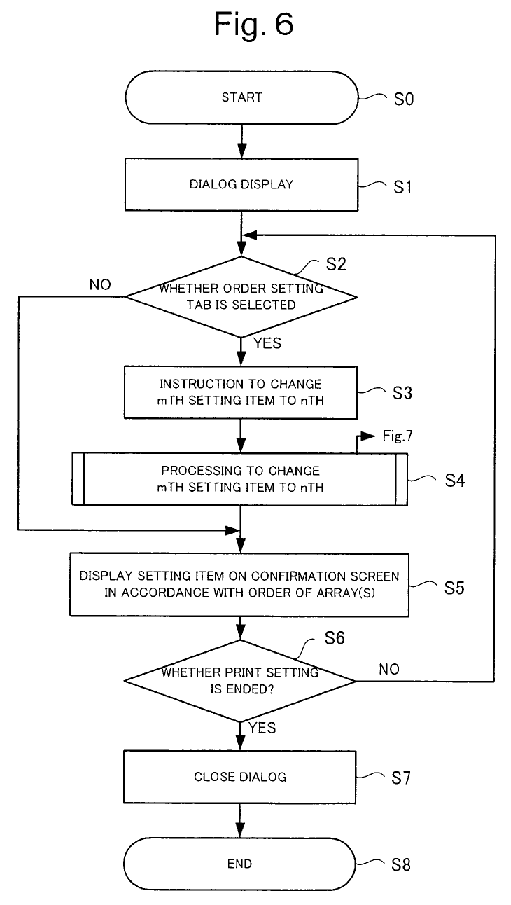

FIG. 6 is a flowchart at the time when the display order of the setting items displayed on the confirmation screen B is changed. At start step S1, when the user performs an operation of print setting, at step S2, the dialog (FIG. 4) of the print setting is displayed. This may be displayed when a print processing is performed from an application, or may be displayed from the property of the printer driver 18.

At step S2, it is judged whether or not the user has selected the tab 51 of “order specification”. In the case where the tab 51 of “order specification” has been selected, an advance is made to next step S3, and in the case where it is not selected, a shift is made to step S5. At step S3, the setting screen 52 shown in FIG. 5A is displayed, and the rearrangement of the order of the setting items is instructed by the user. Here, it is assumed that an operation (instruction) to change an mth setting item to an nth one (m≠n) is performed.

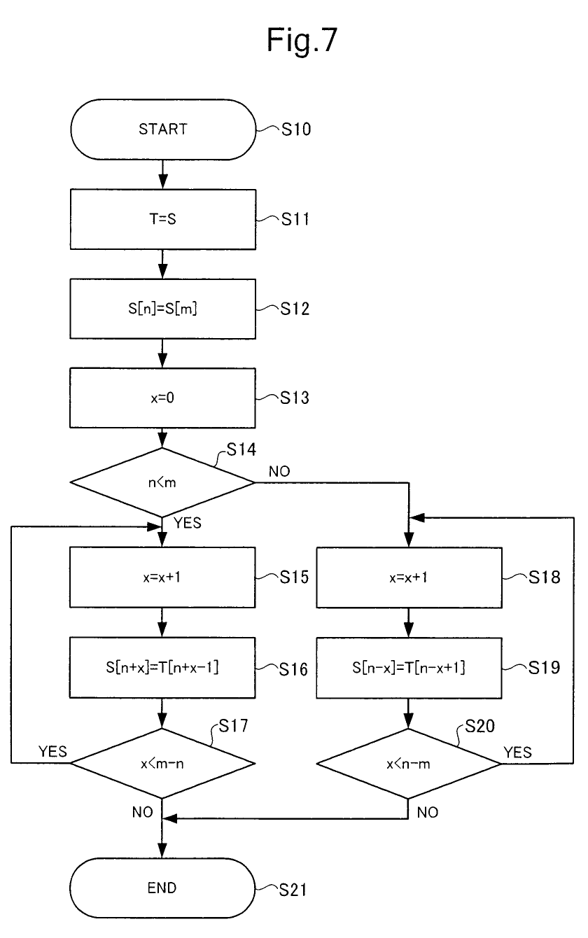

Next, at step S4, a processing to change the mth setting item to the nth one is performed. The processing at the time when the items are rearranged is in accordance with a flowchart of FIG. 7. By this, as shown in FIG. 5B, the order of the setting items is rearranged, and the fifth item “printing direction” in FIG. 5A is changed to the third one. At step S5, in accordance with the order of an array S (see FIG. 7), the setting items are displayed on the confirmation screen B.

Step S6 is a step of judging whether or not the print setting by the user is ended, and in the case where the print setting is not ended, a return is made to step S2, and when the print setting is ended, an advance is made to step S7, the dialog of the print setting is closed, and the end occurs at step S8.

The flowchart of FIG. 7 shows the details of step S4 of FIG. 6 and shows the processing to change the mth setting item to the nth one, and includes step S10 to step S21. In FIG. 7, S denotes an array of print setting items, and T denotes a temporary array. In the flowchart of FIG. 7, in the case where the order of the mth setting item is changed to be lower than that of the nth setting item, a shift is made to step S21 from step S14 through steps S15, S16 and S17. In the case where the order of the mth setting item is changed to be higher than that of the nth setting item, a shift is made to step S21 from step S14 through steps S18, S19 and S20.

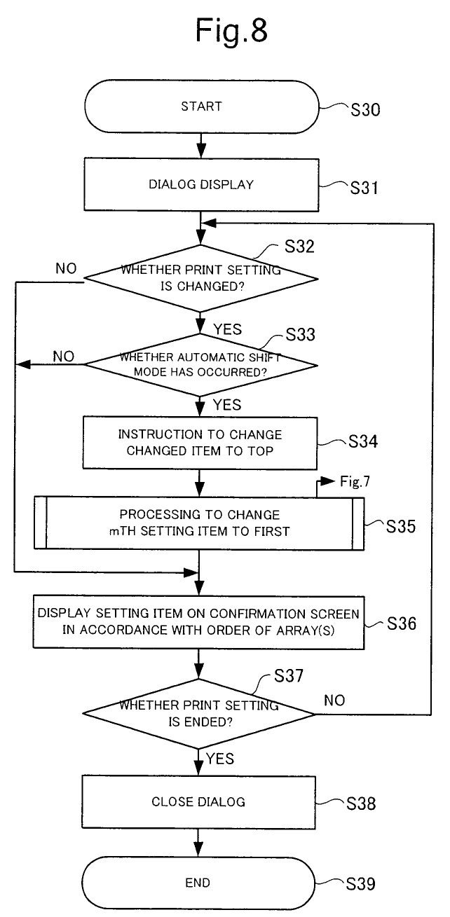

FIG. 8 is a flowchart for explaining an operation of another embodiment of the invention. In this example, with respect to the display order of the setting items displayed on the confirmation screen B, when the user changes print setting, the changed setting item is automatically shifted to the top of the confirmation screen B.

At start step S30 of FIG. 8, when the user performs an operation of print setting, at step S31, the dialog (FIG. 4) of the print setting is displayed. At step S32, it is judged whether or not the user has changed the print setting. In the case where the print setting has been changed, an advance is made to next step S33, and in the case where it is not changed, a shift is made to step S36.

At step S33, it is judged whether or not a display mode is such that the changed setting item is shifted to the top. That is, since there is also a case where some user desires that the display order on the confirmation screen B is not changed and the current display remains as it is, at step S33, the display mode desired by the user is judged. Incidentally, the display mode in which the changed setting item is changed to the top when the user changes print setting is called an automatic shift mode.

In the case of the automatic shift mode, an advance is made to step S34, and an instruction to change the display order (mth) of the changed setting item on the confirmation screen B to the first is issued. Next, at step S35, the processing to change the mth setting item to the first one is performed, the setting item changed by the user is changed to the top of the confirmation screen B, and the other setting items are sequentially moved down. The processing at the time when the items are rearranged is in accordance with the flowchart of FIG. 7.

At step S36, in accordance with the order of the array S, the print setting item is displayed at the top on the confirmation screen B. Step S37 is a step of judging whether or not the print setting by the user is ended, and in the case where the print setting is not ended, a return is made to step S32, and when the print setting is ended, an advance is made to step S38, the dialog of the print setting is closed, and the end occurs at step S39.

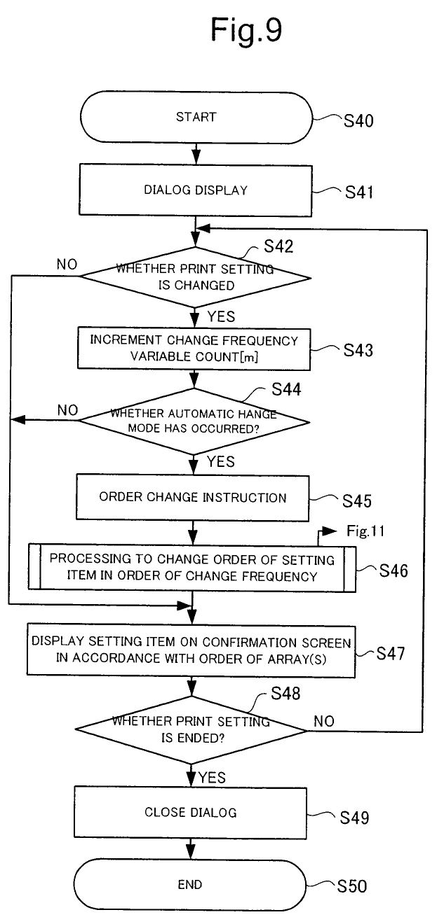

FIG. 9 is a flowchart for explaining an operation of still another embodiment. In this example, the display order of setting items displayed on the confirmation screen B is automatically changed according to the change frequency of each setting item when the user changes print setting.

At start step S40 of FIG. 9, when the user performs the operation of the print setting, the dialog (FIG. 4) of the print setting is displayed at step S41. At step S42, it is judged whether or not the user has changed the print setting In the case where the print setting is changed, an advance is made to next step S43, and in the case where it is not changed, a shift is made to step S47.

At step S43, the variable of the change frequency of the setting item changed by the user is incremented.

At step S44, it is judged whether or not a mode is such that the display order of the setting items is automatically changed to the order of the variable of the change frequency. That is, since there is also a case where some user desires that the display order on the confirmation screen B is not changed and the current display remains as it is, at step S44, the display mode desired by the user is judged. Incidentally, the mode in which the display order of setting items is automatically changed to the order of the variable of the change frequency is called an automatic change mode.

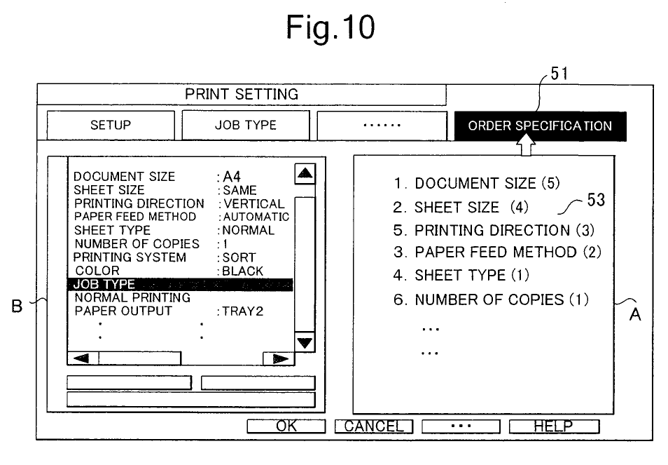

In the case of the automatic change mode, an advance is made to step S45, and an instruction to change the display order on the confirmation screen B to the order of the change frequency is issued. At this time, a setting screen 53 shown in FIG. 10 is displayed, and an instruction is issued to rearrange the print setting items in the order of the change frequency.

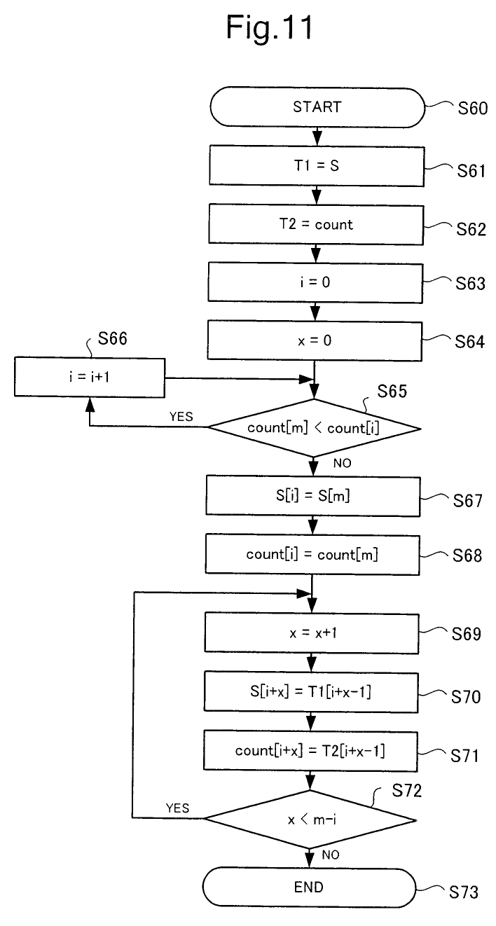

Next, at step S46, a processing to change the order of setting items to the order of the change frequency is performed, and at step S47, the print setting items are displayed on the confirmation screen B in accordance with the order of the array S. The display order on the confirmation screen B is rearranged in the order of the change frequency as shown in FIG. 10. Incidentally, the processing to change the order of setting items at step S46 is in accordance with a flowchart of FIG. 11.

Further, step S48 is a step of judging whether or not the print setting by the user is ended, and in the case where the print setting is not ended, a return is made to step S42, and when the print setting is ended, an advance is made to step S49, the dialog of the print setting is closed, and the end occurs at step S50. By the above processing, the print setting items are always displayed on the confirmation screen B in the order of the change frequency.

The flowchart of FIG. 11 shows a processing to rearrange the setting items on the confirmation screen B in the order of the change frequency, and includes step S60 to step S73. In FIG. 11, S denotes an array of the print setting items, and [count] denotes an array of the change frequency. Besides, T1 denotes a temporary array 1, and T2 denotes a temporary array 2.

In the flowchart of FIG. 11, the respective change frequencies of the plural setting items are compared with each other, and the setting items on the confirmation screen B are rearranged in the order of the change frequency. For example, in the case where the mth displayed setting item is changed, the setting item is rearranged in the order of suitable change frequency and is displayed. That is, an example is shown in which S[m] of FIG. 11 denotes an mth displayed setting item, count [m] denotes the change frequency of the mth displayed setting item, and the mth setting item is changed and is ith displayed since the change frequency is increased.

Since the data such as the printing conditions set by the user and the data indicating the display order on the confirmation screen B are stored in the data storage area 192 of the storage unit 19, after the printing conditions are set, a display can be performed in the arrangement order based on the stored data.

As described above, according to the invention, the set printing conditions can be confirmed by looking at the confirmation screen B displayed in the dialog of the print setting. The setting items displayed on the confirmation screen B can be displayed in the order specified by the user, or can be displayed while the setting item changed when the user changes the print setting is automatically shifted to the top. Alternatively, when the user changes the print setting, automatic rearrangement is performed according to the change frequencies of the setting items, and a display can be performed. Thus, when the user confirms the printing conditions later, they can be displayed in the order in which the user can easily look at.

Although exemplary embodiments of the present invention have been shown and described, it will be apparent to those having ordinary skill in the art that a number of changes, modifications, or alterations to the invention as described herein may be made, non of which depart from the spirit of the present invention. All such changes, modifications, and alterations should therefore be seen as within the scope of the present invention.

What is claimed is:

1. A printing system which outputs image data created by a computer apparatus to an image forming apparatus and performs a print processing, comprising:
the computer apparatus, having
a data conversion unit configured to convert, when image data created by a data creation unit is outputted to the image forming apparatus and the print processing is performed, the image data into print data based on a previously set printing condition;
a dialog image creation unit configured to create a dialog image including a print setting screen for setting the printing condition and a confirmation screen for enabling the set printing condition to be confirmed for each item;
a display unit configured to display the dialog image; and
a display change unit configured to change a display order of plural setting items displayed on the confirmation screen based on an operation of a user,
the image forming apparatus includes a printer that can perform the print processing in accordance with the set printing condition.

2. The printing system according to claim 1, characterized in that
the computer apparatus includes an input unit in which the user operation can be performed, and
the display change unit changes the display order of the setting items on the confirmation screen to an order specified by the user.

3. The printing system according to claim 2, characterized in that specification of the display order by the user is performed by drag-and-drop of an arbitrary setting item displayed on the confirmation screen.

4. The printing system according to claim 1, characterized in that
the computer apparatus includes an input unit in which the user operation can be performed, and
with respect to the display order of the setting items displayed on the confirmation screen, when the printing condition is changed by the user, the display change unit shifts a setting item, in which the printing condition is changed, to an upper level.

5. The printing system according to claim 4, characterized in that the user can select whether the shift of the display order by the display change unit is automatically performed in response to the change of the printing condition.

6. The printing system according to claim 1, characterized in that
the computer apparatus includes an input unit in which the user operation can be performed, and
the display change unit changes the display order of the setting items on the confirmation screen in descending order of change frequencies of the setting items based on an frequency at which the printing condition is changed by the user.

7. The printing system according to claim 6, characterized in that the user can select whether the change of the display order by the display change unit is automatically performed in response to the change frequency of the printing condition.

8. The printing system according to claim 1, characterized in that the computer apparatus and the image forming apparatus are connected to each other through a network.

9. The printing system according to claim 1, characterized in that a tab to specify the order is provided in the dialog image, and when change setting of the display order on the confirmation screen is performed, a screen for the change setting of the order is displayed by using the tab.

10. A printing method of performing a print processing of image data created by a computer apparatus, comprising:
creating a dialog image including a print setting screen for setting a printing condition and a confirmation screen for enabling the set printing condition to be confirmed for each item when image data created by a data creation unit of the computer apparatus is print-processed, and displaying it on display means;
setting a printing condition by using the print setting screen displayed on the display means;
changing, based on an operation of a user, a display order of plural setting items displayed on the confirmation screen;
converting the image data into print data based on the set printing condition; and
performing a print processing of the converted print data by a printer.

11. The printing method according to claim 10, characterized in that the display order of the setting items displayed on the confirmation screen is changed to an order specified by the user.

12. The printing method according to claim 10, characterized in that with respect to the change of the display order of the setting items displayed on the confirmation screen, when the printing condition is changed by the user, a setting item in which the printing condition is changed is shifted to an upper level.

13. The printing method according to claim 10, characterized in that the display order of the setting items displayed on the confirmation screen is changed to descending order of change frequencies of the setting items based on a frequency at which the printing condition is changed by the user.

14. A computer readable storage medium storing a program used for a print processing of image data, the stored program realizing:
a data conversion function to convert, when image data created by a data creation unit is print-processed, the image data into print data based on a previously set printing condition;
a function to create a dialog image including a print setting screen for setting the printing condition and a confirmation screen for enabling the set printing condition to be confirmed for each item; and
a display change function to change a display order of plural setting items displayed on the confirmation screen based on an operation of a user.

15. The storage medium according to claim 14, characterized in that the program of the display change function includes a program to change the display order of the setting items on the confirmation screen to an order specified by the user.

16. The storage medium according to claim 14, characterized in that with respect to the display order of the setting items displayed on the confirmation screen, the program of the display change function includes a program to shift, when the printing condition is changed by the user, a setting item, in which the printing condition is changed, to an upper level.

17. The storage medium according to claim 14, characterized in that the program of the display change function includes a program to change the display order of the setting items on the confirmation screen to descending order of change frequencies of the setting items based on a frequency at which the printing condition is changed by the user.

18. A printing system which outputs image data created by a computer apparatus to an image forming apparatus and performs a print processing, comprising:
the computer apparatus, having
data conversion means for converting, when image data created by a data creation unit is outputted to the image forming apparatus and the print processing is performed, the image data into print data based on a previously set printing condition;
dialog image creation means for creating a dialog image including a print setting screen for setting the printing condition and a confirmation screen for enabling the set printing condition to be confirmed for each item;
display means for displaying the dialog image created by the dialog image creation means; and
display change means for changing a display order of plural setting items displayed on the confirmation screen based on an operation of a user,
the image forming apparatus includes print means that can perform the print processing in accordance with the set printing condition.
